(19) United States
(12) Patent Application Publication
(10) Pub. No.: US 2021/0387370 A1
(43) Pub. Date: Dec. 16, 2021

(54) MAGNETIC CUTTING AND STAMPING PAD, PATTERN CUTTING AND STAMPING MACHINE, AND CUTTING AND STAMPING METHOD

(71) Applicant: PARRIC NINGBO STATIONERY AND GIFTS MFG. CO., LTD, Ningbo City (CN)

(72) Inventor: Fuping Li, Ningbo City (CN)

(21) Appl. No.: 17/141,958

(22) Filed: Jan. 5, 2021

Related U.S. Application Data
(63) Continuation-in-part of application No. PCT/CN2019/102049, filed on Aug. 22, 2019.

(30) Foreign Application Priority Data
Jul. 6, 2018 (CN) 201821074119.3

(51) Int. Cl. B26F 1/42; B26D 7/20

(52) U.S. Cl. CPC B26F 1/42; B26D 2007/0093; B26D 7/20

(57) ABSTRACT

A magnetic cutting and stamping pad (33), comprising a magnetic layer (331), and the magnetic layer (331) is connected to a pad layer (332) at a side facing a pattern medium (4); the magnetic field generated by the magnetic layer (331) penetrates the pad layer (332) and the pattern medium (4), attracts a cutting blade (5); during cutting and stamping, the cutting blade (5) completely penetrates the pattern medium (4) and enters above the pad layer (332), thereby ensuring that during the cutting and stamping the cutting blade (5) completely cuts out the pattern desired. The magnetic cutting and stamping pad (33) can position the relative locations of the cutting blade (5) and the pattern medium (4). The present invention also relates to a pattern cutting and stamping machine comprising the magnetic cutting and stamping pad (33), and a cutting and stamping method.

### FIELD OF INVENTION

The present invention relates to the technical field of pattern cutting and stamping machines, in particular to a magnetic cutting and stamping pad, a pattern cutting and stamping machine, and their cutting and stamping method.

### BACKGROUND OF INVENTION

### Description of the Related Art

At present, pattern media including paper, plastic sheet, cork, metal sheet, leather, and EVA are generally stamped or cut by a pattern cutting and stamping tool as shown in FIG. 1, and the pattern cutting and stamping tool usually includes a cutting and stamping board 3 consisted of two pieces of independent boards, respectively: an upper cutting and stamping board 31 and a lower cutting and stamping board 32. A pattern medium 4 and a cutting blade 5 are bound and placed on a surface of one of the cutting and stamping boards and clamped between the two cutting and stamping boards. A pressure roller or any equivalent pressure device is used to press the upper cutting and stamping board and the lower cutting and stamping board in order to attach them closely with each other, and the cutting and stamping board presses the cutting blade to stamp a pattern at the pattern medium, and the pattern of the cutting blade stamps on the surface of the pattern medium to produce a corresponding pattern, and a knife of the cutting blade cuts and separates the pattern from the pattern medium (It is noteworthy that just one cutting and stamping board may be used in some cases, wherein the pattern medium is placed on a surface of the cutting and stamping board, and a pressure roller or any other pressure device presses the cutting blade directly to act on the pattern medium).

However, the prior art has the following drawbacks: After the pattern medium and the cutting blade are placed on the surface of the cutting and stamping board, the positional relationship between the cutting blade and the pattern medium may be distributed easily, so that the cutting blade and the pattern medium may be distributed and cannot be fixed. As a result, a displacement may occur, and the positioning between the cutting blade and the pattern medium is misaligned, and a cutting misalignment is produced. Especially, it is likely to have alignment errors or damages of the pattern for the continuous arrangement of patterns on the pattern medium during the cutting and stamping process. In addition, the cutting misalignment of the pattern also affects users' experience of using the present existing technology. The conventional pattern cutting and stamping machine may not be able to completely cut out a desired pattern by the cutting blade, so that the thickness of the cut pattern will be limited. If the squeezing force of the pressure roller is too large, it will also cause the cutting blade to be worn and damaged easily and reduce the service life of the cutting blade.

### SUMMARY OF THE INVENTION

(1) Problems to be Solved

The present invention intends to overcome the technical problem by providing a magnetic cutting and stamping pad, a pattern cutting and stamping machine and their cutting and stamping method, and the magnetic cutting and stamping pad can position the cutting blade relative to the pattern medium and has a pad layer, and the pattern cutting and stamping machine and its cutting and stamping method can be used to ensure that the cutting blade will not be damaged when the cutting blade completely cut and stamp the desired pattern at the required position.

(2) Technical Solutions

To overcome the aforementioned technical problem, the present invention provides a magnetic cutting and stamping pad, a pattern cutting and stamping machine and their cutting and stamping method, wherein the magnetic cutting and stamping pad comprises a magnetic layer having a pad layer coupled to a side of the magnetic layer facing a pattern medium; a magnetic field generated by the magnetic layer passes through the pad layer and the pattern medium to attract a cutting blade, and maintains a stable positional relationship between them; during the cutting and stamping process, the cutting blade completely penetrates through the pattern medium and drops onto the pad layer, and can completely cut and stamp a desired pattern during the cutting and stamping process, and the pad layer is provided for preventing the cutting blade from being damaged when a thick pattern is cut and stamped.

The pad layer is designed specifically according to a specific effect of the cutting blade on different pattern media in order to obtain a better production effect of the pattern and a longer service life of the magnetic cutting and stamping pad.

Wherein, the pad layer is an elastic structure, and when a pressure is exerted on the cutting blade, the cutting blade can be passed across the pattern medium reliably to cut the pattern from the pattern medium stably, so that the cut and stamped pattern has clear edges, and the pattern lines can be fully embossed on the pattern medium, and this structure is specially suitable for a thin pattern medium such as cutting paper, EVA, and cork.

In a technical solution parallel to the aforementioned technical solution, the pad layer is a hard structure which is suitable for a pattern medium with high tenacity such as polyvinyl chloride (PVC), polyethylene terephthalate (PET), polyterephthalic acid, etc. and capable of ensuring that the pattern medium can be cut reliably.

Further, the pad layer and the magnetic layer are bound and coupled with each other by a bonding layer.

Further, the magnetic cutting and stamping pad has a thickness of 2˜8 mm, preferably 3 mm. The magnetic layer has a thickness of 1.5 mm, and the pad layer has a thickness of 1.5 mm.

In the aforementioned technical solution, a soft magnetic sheet may be used for the magnetic layer, and a PVC or PP material may be used for the pad layer, and other suitable materials may be used in practical productions; a composite glue is applied between the magnetic layer and the pad layer for the bonding purpose, wherein the composite glue is a double sided adhesive tape substrate made of a high tensile polyethylene terephthalate (PET) material, and both sides of the substrate are coated with a modified polyacrylate binder, so that the composite glue has super high adhesiveness, excellent adhesion performance, and strong dimensional stability to ensure the product adhesion performance of the product and prevent the product from being deformed or displaced. To achieve a better cutting and stamping effect, after the material of the magnetic cutting and stamping pad is selected, the magnetic field intensity of a side of the composite magnetic cutting and stamping pad that faces the upper cutting and stamping board should be 50˜700 Gs, preferably 250 Gs; and the magnetic field intensity of a side of the composite magnetic cutting and stamping pad that faces the lower cutting and stamping board should be 50˜700 Gs, preferably 350 Gs.

Further, another technical solution of this invention further provides a pattern cutting and stamping machine including the aforementioned magnetic cutting and stamping pad, and the pattern cutting and stamping machine comprises a cutting and stamping board and a pressure roller, and the cutting and stamping board comprises an upper cutting and stamping board and a lower cutting and stamping board, and the pattern medium and the cutting blade are clamped between the upper cutting and stamping board and the lower cutting and stamping board; the magnetic cutting and stamping pad is coupled to the upper cutting and stamping board or the lower cutting and stamping board, and the pattern medium is laid on a pad layer surface of the magnetic cutting and stamping pad, and a magnetic field generated by the magnetic layer of the magnetic cutting and stamping pad passes through the pattern medium to attract the cutting blade. When use, the pressure roller presses the upper cutting and stamping board and the lower cutting and stamping board, so as to press the cutting blade to cut out a pattern from the pattern medium. Compared to a conventional pattern cutting and stamping machine, the pattern cutting and stamping machine of the present invention can cut a thicker pattern without damaging the cutting blade and improve the cutting and stamping quality and the overall service life.

Further, a bonding layer or a bonding point is disposed between the magnetic cutting and stamping pad and the cutting and stamping board and provided for bonding the magnetic cutting and stamping pad with the cutting and stamping board to achieve a detachable connection between the magnetic cutting and stamping pad and the cutting and stamping board by a lower cost.

In another technical solution parallel to the aforementioned technical solution, the cutting and stamping board has an iron sheet layer disposed on a surface of the cutting and stamping board, and the magnetic cutting and stamping pad and the iron sheet layer magnetically attract one another to facilitate the process of separating the magnetic cutting and stamping pad from the iron sheet layer quickly to improve the convenience of changing the magnetic cutting and stamping pad.

In another technical solution parallel to the aforementioned technical solution, the cutting and stamping board has a magnetic fixed layer disposed on a surface of the cutting and stamping board, and the magnetic cutting and stamping pad and the magnetic fixed layer magnetically attract one another to enhance the strength of connection between the magnetic cutting and stamping pad and the magnetic fixed layer and improve the convenience of changing the magnetic cutting and stamping pad.

This disclosure further provides a cutting and stamping method of a pattern cutting and stamping machine, and the method is applied to the aforementioned pattern cutting and stamping machine, and the method comprises the following steps:

Step (S001): Placement of pattern medium: Put a pattern medium directly on a pad layer of a magnetic cutting and stamping pad; wherein the magnetic cutting and stamping pad is coupled to a lower cutting and stamping board of a cutting and stamping board; Step (S002): Attraction of pattern medium: Use a magnetic layer of the magnetic cutting and stamping pad to attract a pattern medium between a cutting blade and the pad layer; Step (S003): Stamping and Cutting of pattern: Rotate a rotating handle of the pattern cutting and stamping machine to drive the pressure roller to rotate, so that the pressure roller presses the upper cutting and stamping board of the cutting and stamping board to be compressed in a direction towards the lower cutting and stamping board, so as to press the cutting blade to pass through the pattern medium which is disposed on the pad layer, and cut a desired pattern from the pattern medium the cutting blade.

Further, in the Step S001, an iron sheet layer is fixed to a surface of the cutting and stamping board and provided for magnetically attract the magnetic cutting and stamping pad and the iron sheet layer with each other.

In another technical solution parallel to the aforementioned technical solution, in the Step S001, a bonding layer or a bonding point is formed between the magnetic cutting and stamping pad and the cutting and stamping board and provided for bonding the magnetic cutting and stamping pad with the cutting and stamping board.

(3) Beneficial Effects

Compared with the prior art, the magnetic cutting and stamping pad of the present invention is provided for maintaining a stable positional relationship between the pattern medium, the cutting blade and the magnetic cutting and stamping pad. The design of the magnetic cutting and stamping pad with the pad layer can improve the service life of the pad layer, the magnetic cutting and stamping pad, and the cutting blade.

With the elastic structure of the pad layer, the pattern can be cut stably from the pattern medium, and the cutting and stamping board and other mechanisms of the pattern cutting and stamping machine can be protected by the elastic protection of the magnetic cutting and stamping pad, so as to avoid the mutual rigid contact or damage, and this structure is especially suitable for cutting and stamping a thin pattern medium such as paper, EVA, and cork. With the hard structure of the pad layer, the pattern can be cut reliably from the pattern medium, and this structure is especially suitable for cutting and stamping a high-tenacity pattern medium such as PVC and PET.

The magnetic cutting and stamping pad is placed on the pattern cutting and stamping machine, and the pattern cutting and stamping machine and the cutting and stamping method produce a cut and stamped pattern which has clear edges, and the surface of the pattern has greater height differences, thereby enhancing the three-dimensional effect of the pattern, and the accuracy of operation and the convenience of use of the pattern cutting and stamping machine, as well as improving the customers' fun of using the pattern cutting and stamping machine.

### BRIEF DESCRIPTION OF THE DRAWINGS

The present invention will become clearer in light of the following detailed description of an illustrative embodiment of this invention described in connection with the drawings.

FIG. 1 is an exploded view of a conventional cutting and stamping board (having a pattern medium, and a cutting blade disposed on a lower cutting and stamping board);

FIG. 2 is an exploded view of a cutting and stamping board of a pattern cutting and stamping machine of the present invention;

FIG. 3 is a blowup view of Section I as depicted in FIG. 2 (which shows a magnetic cutting and stamping pad);

FIG. 4 is a perspective view of a pattern cutting and stamping machine of the present invention;

FIG. 5 is an exploded view of a lower cutting and stamping board and a magnetic cutting and stamping pad of a pattern cutting and stamping machine of the present invention; and

FIG. 6 is a schematic block diagram showing the process of a cutting and stamping method of a pattern cutting and stamping machine of the present invention.

### DESCRIPTION OF NUMERALS USED IN THE DRAWINGS

1: Pattern cutting and stamping machine; 2: rotating handle; 3: cutting and stamping board; 31: upper cutting and stamping board; 32: lower cutting and stamping board; 321: iron sheet layer; 33: magnetic cutting and stamping pad; 331: magnetic layer; 332: pad layer; 4: pattern medium; 5: cutting blade.

### DESCRIPTION OF THE PREFERRED EMBODIMENTS

Exemplary embodiments are illustrated in referenced figures of the drawings. It is intended that the embodiments and figures disclosed herein are to be considered illustrative rather than restrictive.

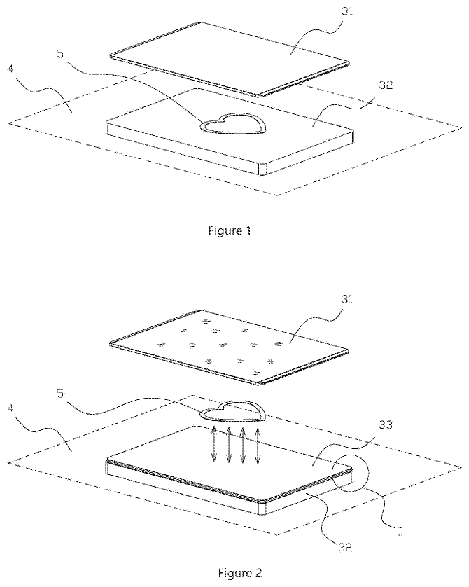

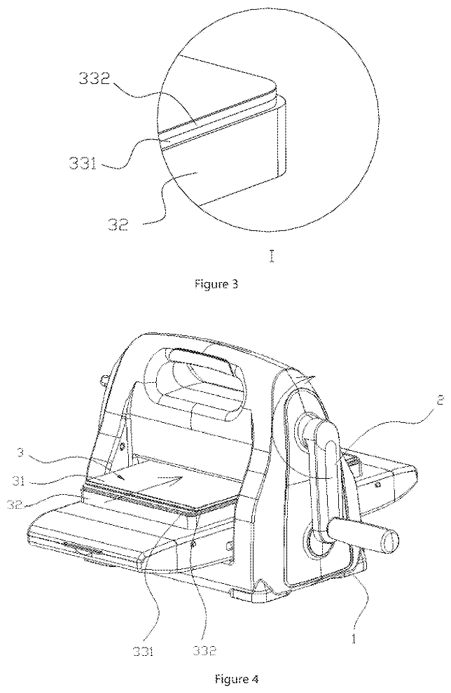

With reference to FIGS. 2 to 6 for a magnetic cutting and stamping pad, a pattern cutting and stamping machine and their cutting and stamping method in accordance with the present invention, the magnetic cutting and stamping pad 33 as shown in FIG. 3 comprises: a magnetic layer 331 with a pad layer 332 disposed on a side of the magnetic layer 331 facing a pattern medium 4; a magnetic field generated by the magnetic layer 331 passes through the pad layer 332 and the pattern medium 4 to attract a cutting blade 5 and maintains a stable positional relationship between them; the cutting blade 5 completely penetrates through the pattern medium 4 and drops onto the pad layer 332 to ensure that the cutting blade 5 can completely cut and stamp the desired pattern during the cutting and stamping process, and the pad layer 332 provides a buffering effect to reduce the worn-out or damage caused by the rigid contact and prevent the cutting blade from being damaged and can cut and stamp a thicker pattern.

The pad layer is designed specifically according to the cutting blade used for cutting different pattern media in order to obtain a better production effect of the pattern and a longer service life of the magnetic cutting and stamping pad.

Wherein, the pad layer 332 is an elastic structure, and when a pressure is exerted onto the cutting blade 5, the cutting blade 5 can be passed across the pattern medium 4 reliably to cut the pattern from the pattern medium 4 stably, so that the cut and stamped pattern has clear edges, and the pattern lines can be fully embossed on the pattern medium 4, and such structure is specially suitable for a thin pattern medium such as cutting paper, EVA, cork, etc. In addition, the pad layer 332 can also be a hard structure which is suitable for a high tenacity pattern medium such as PVC and PET to ensure that the pattern medium can be cut reliably.

Wherein, the pad layer 332 and the magnetic layer 331 are bonded and coupled by a bonding layer.

Wherein, the magnetic cutting and stamping pad 33 has a thickness of 2˜8 mm, preferably 3 mm; the magnetic layer 331 has a thickness of 1.5 mm; and the pad layer 332 has a thickness of 1.5 mm. The magnetic layer 331 is made of a soft magnetic sheet; the pad layer 332 is made of a PVC or PP material; and other materials can also be used in practical productions; a composite glue is applied between the magnetic layer and the pad layer for the bonding purpose, wherein the composite glue is a double sided adhesive tape substrate made of a high tensile polyethylene terephthalate (PET) material, and both sides of the substrate are coated with a modified polyacrylate binder, so that the composite glue has super high adhesiveness, excellent adhesion performance, and strong dimensional stability to ensure the product adhesion performance of the product and prevent the product from being deformed or displaced. To achieve a better cutting and stamping effect, after the material of the magnetic cutting and stamping pad is selected, the magnetic field intensity of a side of the composite magnetic cutting and stamping pad that faces the upper cutting and stamping board should be 50˜700 Gs, preferably 250 Gs; and the magnetic field intensity of a side of the composite magnetic cutting and stamping pad that faces the lower cutting and stamping board should be 50˜700 Gs, preferably 350 Gs.

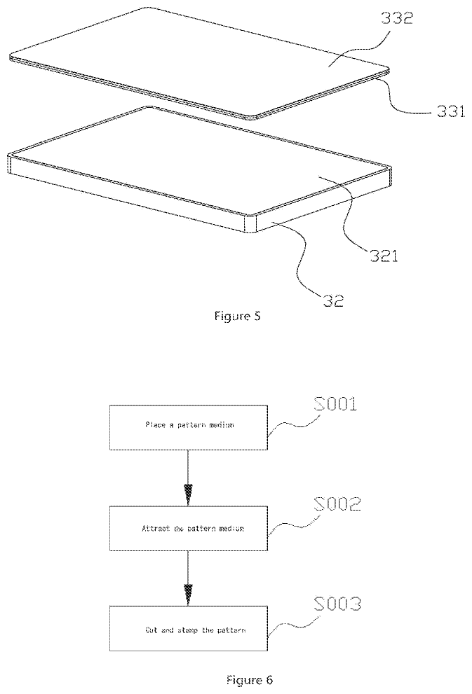

With reference to FIGS. 4 and 5, the present invention further provides a pattern cutting and stamping machine comprising the aforementioned magnetic cutting and stamping pad 33, and the pattern cutting and stamping machine 1 further comprises a cutting and stamping board 3 and a pressure roller, and the cutting and stamping board 3 comprises an upper cutting and stamping board 31 and a lower cutting and stamping board 32, and the pattern medium 4 and the cutting blade 5 are clamped between the upper cutting and stamping board 31 and the lower cutting and stamping board 32; the magnetic cutting and stamping pad 33 is coupled to the upper cutting and stamping board 31 or the lower cutting and stamping board 32 (In this embodiment, the magnetic cutting and stamping pad 33 is coupled to the lower cutting and stamping board 32 and placed on the pattern medium 4 by gravity. In some cases, such as after the pattern is cut and stamped, it is necessary to separate the cut and stamped pattern from the pattern medium 4 by oneself, before an upper surface of the magnetic cutting and stamping pad 33 is bound with the upper cutting and stamping board 31, and the pattern medium 4 is laid on a lower surface of the magnetic cutting and stamping pad 33. The cutting blade 5 and the magnetic cutting and stamping pad 33 are magnetically attracted to each other, so that the pattern medium 4 an the magnetic cutting and stamping pad 33 can be kept to be bound with each other), and the pattern medium 4 is laid on a surface of the pad layer 332 of the magnetic cutting and stamping pad 33, and magnetic field generated by the magnetic layer 331 of the magnetic cutting and stamping pad 33 passes through the pattern medium 4 to attract the cutting blade 5. When use, the pressure roller presses the upper cutting and stamping board 31 and the lower cutting and stamping board 32, and in turn to press the cutting blade 5 in order to cut a pattern from the pattern medium 4. Wherein, the upper cutting and stamping board 31 is a transparent structure to facilitate observing the placement of the pattern medium and the cutting blade.

In FIG. 5, an iron sheet layer 321 is disposed on a surface of the cutting and stamping board 3 of this embodiment, so that the magnetic cutting and stamping pad 33 and the iron sheet layer 321 magnetically attract each other to facilitate a separation of the magnetic cutting and stamping pad 33 from the iron sheet layer 321 quickly and improve the convenience of changing the magnetic cutting and stamping pad 33.

In addition, a bonding layer or a bonding point may be included between the magnetic cutting and stamping pad 33 and the cutting and stamping board 3 in order to bond the magnetic cutting and stamping pad 33 with the cutting and stamping board 3, and achieve a detachable connection between the magnetic cutting and stamping pad 33 and the cutting and stamping board 3 by a low cost, or the surface of the cutting and stamping board 3 may have a magnetic fixed layer, so that the magnetic cutting and stamping pad 33 and the magnetic fixed layer can be magnetically attracted to one another in order to enhance the strength of the connection between the magnetic cutting and stamping pad 33 and the magnetic fixed layer and the convenience of changing the magnetic cutting and stamping pad 33.

In FIG. 6, this embodiment further provides a cutting and stamping method for the pattern cutting and stamping machine, and the method is applied to the pattern cutting and stamping machine, and comprises the following steps: Step (S001): Placement of pattern medium: Place a pattern medium 4 directly on the pad layer 332 of the magnetic cutting and stamping pad 33 of the pattern cutting and stamping machine 1, wherein the magnetic cutting and stamping pad 33 is coupled to the lower cutting and stamping board 32 of the cutting and stamping board 3 of the pattern cutting and stamping machine 1; Step (S002): Attraction of pattern medium: Use the magnetic layer 331 of the magnetic cutting and stamping pad 33 to attract a pattern medium 4 between the cutting blade 5 and the pad layer 332; and Step (S003): Stamping and Cutting of pattern: Rotate a rotating handle 2 of the pattern cutting and stamping machine to drive the pressure roller to rotate, so that the pressure roller presses the upper cutting and stamping board 31 of the cutting and stamping board 3 to be compressed in a direction towards the lower cutting and stamping board 32, so as to press the cutting blade 5 to pass through the pattern medium 4 which is placed on the pad layer 332, and finally cut a desired pattern from the pattern medium 4 by the cutting blade 5.

Wherein, in the Step (S001), an iron sheet layer 321 is disposed on a surface of the cutting and stamping board 3, so that the magnetic cutting and stamping pad 33 and the iron sheet layer 321 are magnetically attracted to each other. In addition, a bonding layer or a bonding point is formed between the magnetic cutting and stamping pad 33 and the cutting and stamping board 3 and provided for bonding the magnetic cutting and stamping pad 33 and the cutting and stamping board 3 with each other.

Compared with the prior art, the magnetic cutting and stamping pad of this disclosure can maintain a stable positional relationship between the pattern medium, the cutting blade, the magnetic cutting and the stamping pad. With the design of the magnetic cutting and stamping pad having a pad layer, such design can improve the service life of the pad layer, the magnetic cutting and stamping pad, and the cutting blade. The pad layer can be an elastic structure, so that the pattern can be cut from the pattern medium stably, and this structure is especially suitable for cutting and stamping a thin pattern medium such as paper, EVA, and cork. With the hard structure of the pad layer, the pattern can be cut reliably from the pattern medium, and this structure is especially suitable for cutting and stamping a high-tenacity pattern medium such as PVC and PET.

The magnetic cutting and stamping pad of this embodiment is installed onto the pattern cutting and stamping machine, and the cut and stamped pattern obtained by the pattern cutting and stamping machine and its cutting and stamping method has clear edges, and the surface of the pattern has a greater height difference to enhance the three-dimensional effect of the pattern and the accuracy of operation and the convenience of use of the pattern cutting and stamping machine and also to improve the users' fun of using the pattern cutting and stamping machine.

While the invention has been described by means of specific embodiments, numerous modifications and variations could be made thereto by those skilled in the art without departing from the scope and spirit of the invention set forth in the claims.

1. A magnetic cutting and stamping pad (33), characterized in that the magnetic cutting and stamping pad (33) comprises a magnetic layer (331), and the magnetic layer (331) is connected to a pad layer (332) at a side facing a pattern medium (4); a magnetic field generated by the magnetic layer (331) penetrates the pad layer (332) and the pattern medium (4), attracts a cutting blade (5); and the cutting blade (5) completely penetrates the pattern medium (4) and falls on above the pad layer (332) during a cutting and stamping process.

2. The magnetic cutting and stamping pad of claim 1, characterized in that the pad layer (332) and the magnetic layer (331) are attached and coupled to each other.

3. The magnetic cutting and stamping pad of claim 1, wherein the magnetic cutting and stamping pad (33) has a thickness of 2˜8 mm.

4. The magnetic cutting and stamping pad of claim 3, wherein the magnetic cutting and stamping pad (33) has a thickness of 3 mm.

5. The magnetic cutting and stamping pad of claim 1, wherein the magnetic layer (331) has a thickness of 1.5 mm.

6. The magnetic cutting and stamping pad of claim 1, wherein the pad layer (332) has a thickness of 1.5 mm.

7. A magnetic cutting and stamping pad device, comprising the magnetic cutting and stamping pad as claimed in claim 1, and further comprising a lower cutting and stamping board (32); the magnetic cutting and stamping pad (33) being detachably coupled to the lower cutting and stamping board (32), and the pattern medium (4) being laid on a surface of the pad layer (332) of the magnetic cutting and stamping pad (33), and a magnetic field generated from a side of the magnetic layer (331) of the magnetic cutting and stamping pad (33) facing the pad layer (332) passing through the pattern medium (4) to attract the cutting blade (5); a side of the magnetic layer (331) of the magnetic cutting and stamping pad (33) facing the lower cutting and stamping board (32) and the lower cutting and stamping board (32) being magnetically attracted to each other.

8. A pattern cutting and stamping machine, comprising the magnetic cutting and stamping pad as claimed in claim 1, characterized in that the pattern cutting stamping machine further comprises a cutting and stamping board (3), and the cutting and stamping board (3) comprises an upper cutting and stamping board (31) and a lower cutting and stamping board (32); the magnetic cutting and stamping pad (33) is coupled to the upper cutting and stamping board (31) or the lower cutting and stamping board (32), and the pattern medium (4) is laid on a surface of the pad layer (332) of the magnetic cutting and stamping pad (33), and a magnetic field generated by the magnetic layer (331) of the magnetic cutting and stamping pad (33) passes through the pattern medium (4) to attract the cutting blade (5).

9. The pattern cutting and stamping machine of claim 8, characterized in that the cutting and stamping board (3) has an iron sheet layer (321) disposed on a surface of the cutting and stamping board (3), and the magnetic cutting and stamping pad (33) and the iron sheet layer (321) magnetically attract each other.

10. The pattern cutting and stamping machine of claim 8, characterized in that the cutting and stamping board (3) has a magnetic fixed layer disposed on a surface of the cutting and stamping board (3), and the magnetic cutting and stamping pad (33) and the magnetic fixed layer magnetically attract each other.

11. The pattern cutting and stamping machine of claim 8, characterized in that the magnetic cutting and stamping pad (33) and the cutting and stamping board (3) have a bonding layer or a bonding point formed therebetween, and the magnetic cutting and stamping pad (33) and the cutting and stamping board (3) are bonded with each other.

12. The pattern cutting and stamping machine of claim 8, wherein the magnetic cutting and stamping pad (33) has a thickness of 2˜8 mm.

13. The pattern cutting and stamping machine of claim 12, wherein the magnetic cutting and stamping pad (33) has a thickness of 3 mm.

14. The pattern cutting and stamping machine of claim 8, wherein the magnetic layer (331) has a thickness of 1.5 mm.

15. The pattern cutting and stamping machine of claim 8, wherein the pad layer (332) has a thickness of 1.5 mm.

16. The pattern cutting and stamping machine of claim 8, wherein the magnetic layer (331) is made of a soft magnetic sheet, and the pad layer (332) is made of a PVC or PP material; the composite magnetic cutting and stamping pad (33) has a magnetic field of 50˜700 Gs generated on a side thereof facing the upper cutting and stamping board (31), and a magnetic field of 50˜700 Gs generated on a side thereof facing the lower cutting and stamping board (32).

17. A cutting and stamping method of the pattern cutting and stamping machine as claimed in claim 8, characterized in that the cutting and stamping method comprises the steps of:
(Step S001): Placement of pattern medium: placing a pattern medium (4) directly on the pad layer (332) of the magnetic cutting and stamping pad (33); wherein the magnetic cutting and stamping pad (33) and the lower cutting and stamping board (32) of the cutting and stamping board (3) are coupled to each other;
(Step S002): Attraction of pattern medium: using the magnetic layer (331) of the magnetic cutting and stamping pad (33) to magnetically attracting the pattern medium between the cutting blade (5) and the pad layer (332); and
(Step S003): Stamping and Cutting of pattern: rotating a rotating handle (2) of the pattern cutting and stamping machine to drive the pressure roller to rotate, so that the pressure roller presses the upper cutting and stamping board (31) of the cutting and stamping board (3) which is compressed in a direction towards the lower cutting and stamping board (32) to press the cutting blade (5) to pass through the pattern medium (4) which is disposed on the pad layer (332), and cutting a desired pattern from the pattern medium (4) by the cutting blade (5).

18. The cutting and stamping method of the pattern cutting and stamping machine as claimed in claim 17, characterized in that in the Step S001, an iron sheet layer (321) is fixed to a surface of the cutting and stamping board (3), and the magnetic cutting and stamping pad (33) and the iron sheet layer (321) magnetically attract each other.

19. The cutting and stamping method of the pattern cutting and stamping machine as claimed in claim 17, characterized in that in the Step S001, a bonding layer or a bonding point is formed between the magnetic cutting and stamping pad (33) and the cutting and stamping board (3) and provided for bonding the magnetic cutting and stamping pad (33) and the cutting and stamping board (3) with each other.
